(19) United States
(12) Patent Application Publication
(10) Pub. No.: US 2024/0285985 A1
(43) Pub. Date: Aug. 29, 2024

(54) HARNESSES

(71) Applicant: TREEMAGINEERS LTD, Pitlochry (GB)

(72) Inventors: Christopher COWELL, Pitlochry (GB); Elliot TANNER, Hyssington, Montgomery (GB)

(21) Appl. No.: 18/571,156

(22) PCT Filed: Jun. 14, 2022
(86) PCT No.: PCT/EP2022/066124

§ 371 Date: Dec. 15, 2023

(30) Foreign Application Priority Data
Jun. 18, 2021 (GB) 2108789.5
Jun. 29, 2021 (GB) 2109336.4

(51) Int. Cl. A62B 35/00

(52) U.S. Cl. CPC A62B 35/0018; A62B 35/0031; A62B 35/0037

(57) ABSTRACT

A harness for supporting a person working at height is disclosed. The harness includes a waist belt, a pair of leg loops and a ventral attachment assembly. The ventral attachment assembly includes a flexible structural component, typically a webbing loop that is secured to the waist belt, and that may be permanently sewn to form a lower bight within, and at least one upper bight that provides a connection point through which loads can be transferred into the waist band. The harness further includes one or a pair of link components, each being connected to a connecting piece and to at least one of the leg loops. The component or components are capable of acting in tension to transfer load from the waist and/or leg loops to the ventral attachment assembly.

### CROSS-REFERENCE TO RELATED APPLICATIONS

This application is the US national stage of PCT/EP2022/066124, filed Jun. 14, 2022 and designating the United States, which claims the priority of GB 2108789.5, filed Jun. 18, 2021, and the priority of GB 2109336.4, filed Jun. 29, 2021. The entire contents of each foregoing application are incorporated herein by reference.

### BACKGROUND TO THE INVENTION

### Field of the Invention

The present invention relates to apparatus for supporting a person at height. It has particular, but not exclusive application to apparatus for supporting a person working at height, for example in the fields of arborism, building construction maintenance or work on the hulls or rigging of marine vessels.

### Description of the Related Art

In a harness, ventral attachment hardware is used to create a front attachment point for a user's harness that can be used to connect to a climbing system, most typically in industrial climbing. A front attachment point can be the main attachment point for a user, can be used during rescue operations, or can be used to suspend devices and masses from the harness. While these attachment points are generally on the front of the user in the waist (ventral) or chest area (sternal), a similar attachment point could also be on the rear shoulder area (dorsal).

An example of a known front harness hardware is disclosed in EP-A-3 228 363 (US-A-2017291047). A disadvantage of this arrangement is that it must be present at all times when the harness is in use, whether or not its function is required; if it is removed, there is no position to attach fall protection systems such as a main line rope adjuster. The harness has only two configurations: with the bosun's seat or without. In addition, the axle does not rotate or rotates to a minimal extent (it is more or less held in place by the loaded shackles located at the end of the axle) so cannot move freely in response to changing loading patterns on the front harness hardware.

### SUMMARY OF THE INVENTION

An aim of this invention is to provide a harness that includes front harness hardware that overcomes or ameliorates these disadvantages.

To this end, from a first aspect, this invention provides a harness for supporting a person working at height preferably comprising one or more of:
a. a waist belt;
b. a pair of leg loops;
c. a ventral attachment assembly, wherein the ventral attachment assembly comprises a flexible structural component that is secured to the waist belt, and that is arranged to form a lower bight within which a connecting piece is retained, and an upper bight that provides a connection point through which loads can be transferred into the waistband; and
d. one or a pair of link components, each being connected to the connecting piece and to one of the leg loops, the link components being capable of acting in tension to transfer load from the waist and/or leg loops to the ventral attachment assembly.

One or more of the waist belt, the leg loops and the link component are typically formed from lengths of webbing.

Typically, the flexible structural component is formed from a length of webbing that is secured to the waist belt and that is permanently formed into upper and lower bights by stitching through the webbing into the waist belt. The flexible structural component may include inner and outer upper bights, the inner upper bight being enclosed within the outer upper bight.

In preferred embodiments of the invention, the ventral attachment assembly further includes ventral attachment hardware that is retained by the flexible structural component and which provides one or more link components to which a connector can be attached to transfer load between the harness and an external component. For example, the ventral attachment hardware may include a plurality of link assemblies interconnected by a connecting piece. Preferably, each link assembly can pivot upon the connecting piece, with the link assemblies (which may be identical) typically pivoting upon the connecting piece about axes that are parallel to one another. At least one link assembly includes an abutment that is disposed to make contact with part of another link assembly to limit the extent to which the link assemblies can rotate towards one another. This arrangement can prevent an object such as a connector, rope or webbing that is passed between link assemblies from being crushed between them.

Typically, the connecting piece is retained within an upper bight (particularly, an inner upper bight) of the flexible structural component. The connecting piece is preferably retained such that it can rotate within the upper bight of the flexible structural component.

Each link assembly may include an attachment link and a removable axle bolt which together form a closed loop, the loop being openable by removal of the axle bolt. Such an attachment link is typically D-shaped. In such embodiments, typically each axle bolt is pivotably retained within a bore of the connecting piece.

In WO-A-2020/065279, the content of which is incorporated herein by reference, the present applicant disclosed a seat assembly that can be deployed on a harness to support a person wearing the harness while working at height. In that disclosure, a seat assembly was connected to and supported form forward connection arrangements of the harness. The present invention may provide an alternative arrangement wherein a seat assembly is connected to and supported form a ventral attachment assembly.

The ventral attachment assembly may include a pair of supplementary connection points to which additional accessory component of the harness can be connected. For example, they may be used as connection points for a seat assembly. Therefore, embodiments of the invention may further include a seat assembly, which seat assembly includes a seat board and a connection component (such as a rope or a webbing), which connection component is connected to the supplementary points. Most typically, the connection component is releasably connected to each supplementary connection point by a removable connector such as a carabiner.

### BRIEF DESCRIPTION OF THE DRAWINGS

An embodiment of the invention will now be described in detail, by way of example, and with reference to the accompanying drawings, in which:

FIG. 1 shows a harness embodying the invention;

FIG. 2 is an enlarged view of part of the harness of FIG. 1;

FIGS. 3 and 4 show ventral attachment hardware of the harness of FIGS. 1 and 2;

FIGS. 5 to 8 are exploded views of the ventral attachment hardware of FIGS. 3 and 4;

FIG. 9 shows a lower D-ring sub-assembly, being a component of the embodiment of FIGS. 1 and 2;

FIG. 10 is a diagrammatic cross-section through a ventral attachment assembly of the harness of FIG. 1;

FIGS. 11a and 11b are a side view of part of ventral attachment hardware of FIGS. 3 and 4 being shown, respectively, at closed and open extremes of pivoting positions of attachment links;

FIG. 12 is a detail showing a connection for a seat assembly; and

FIGS. 13 and 14 show alternative embodiments of ventral attachment hardware embodying the invention.

### DETAILED DESCRIPTION

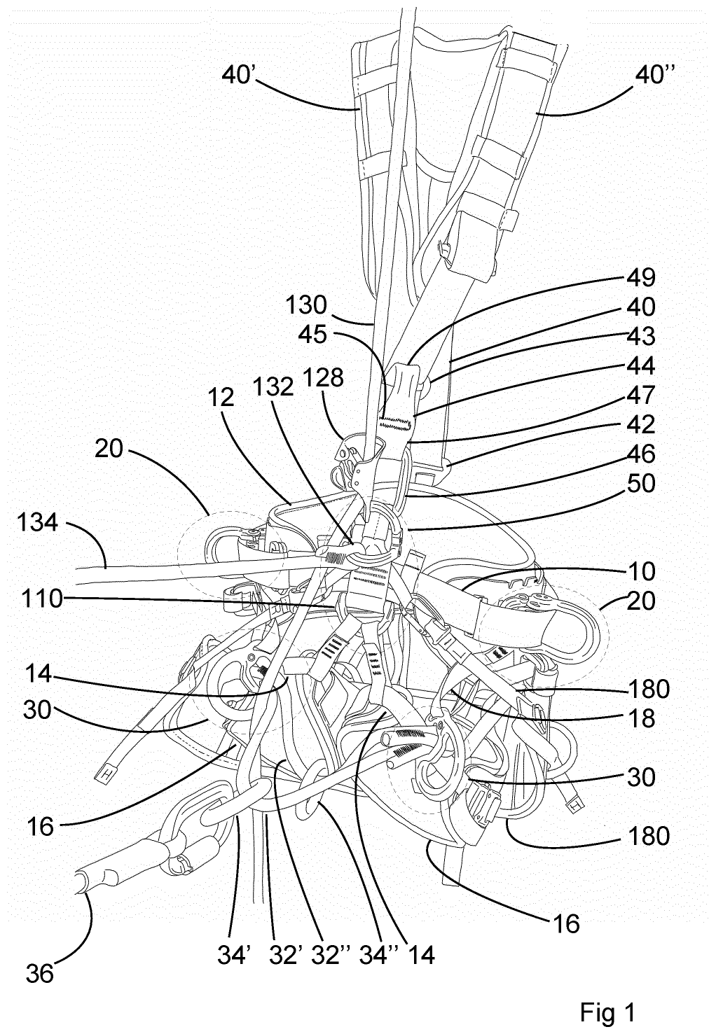

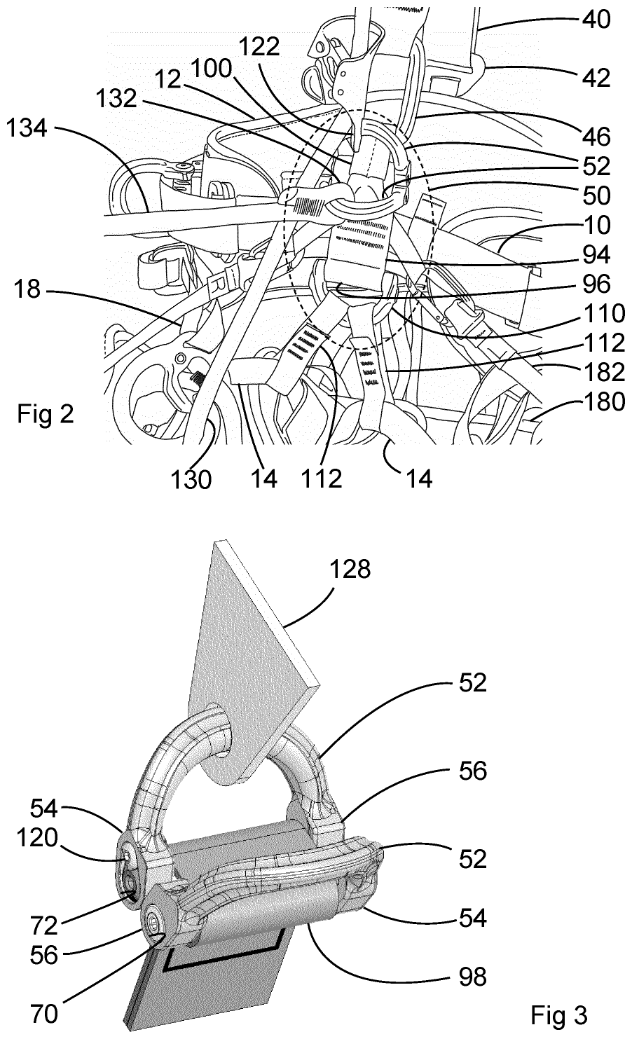

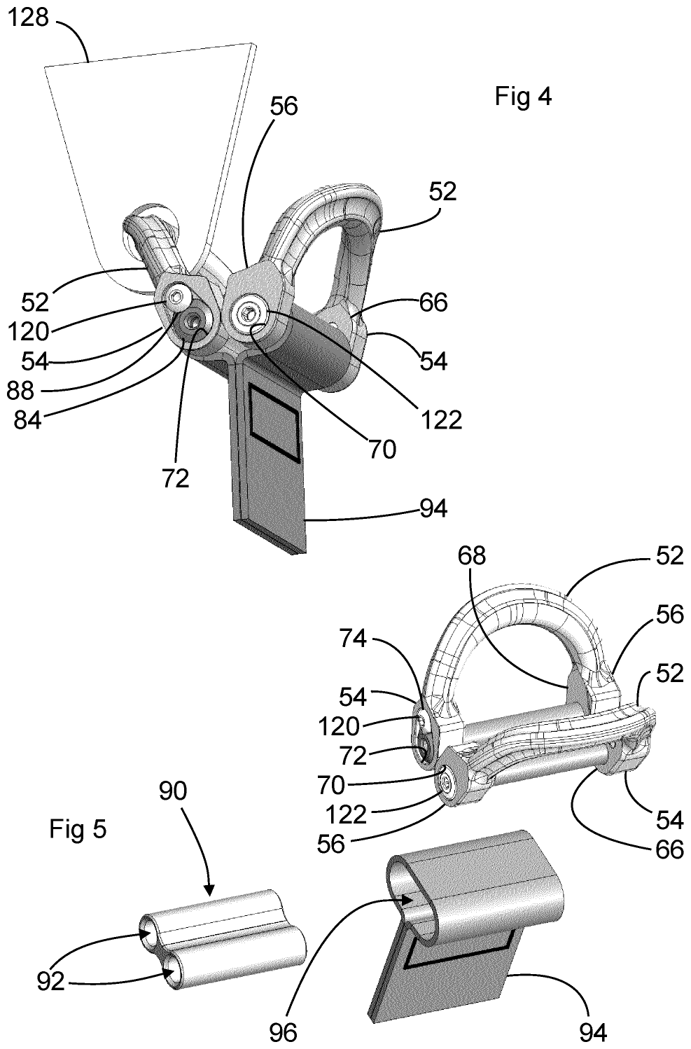

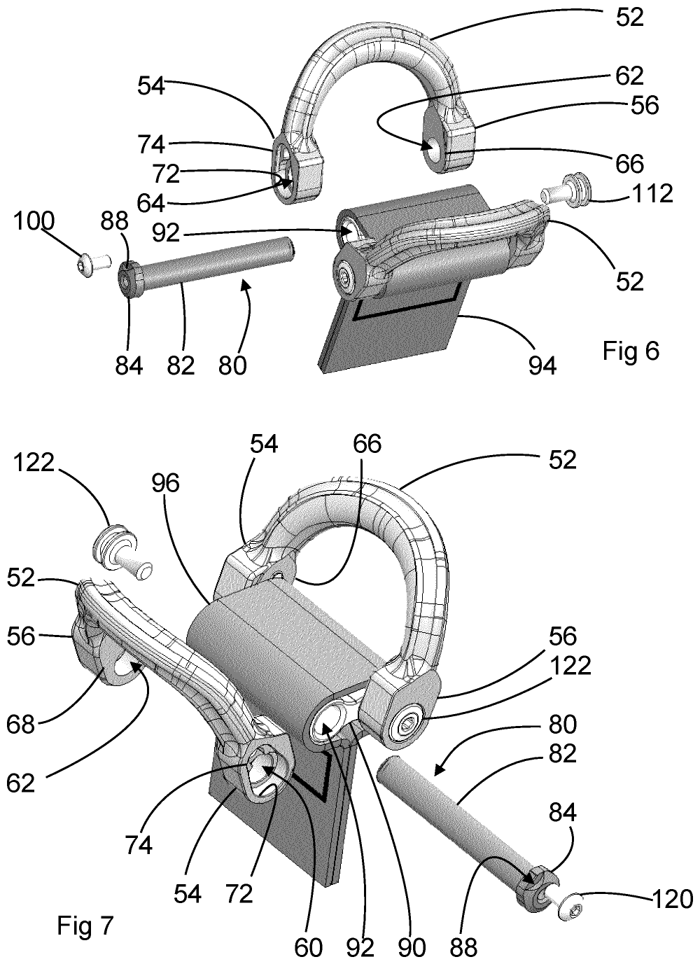

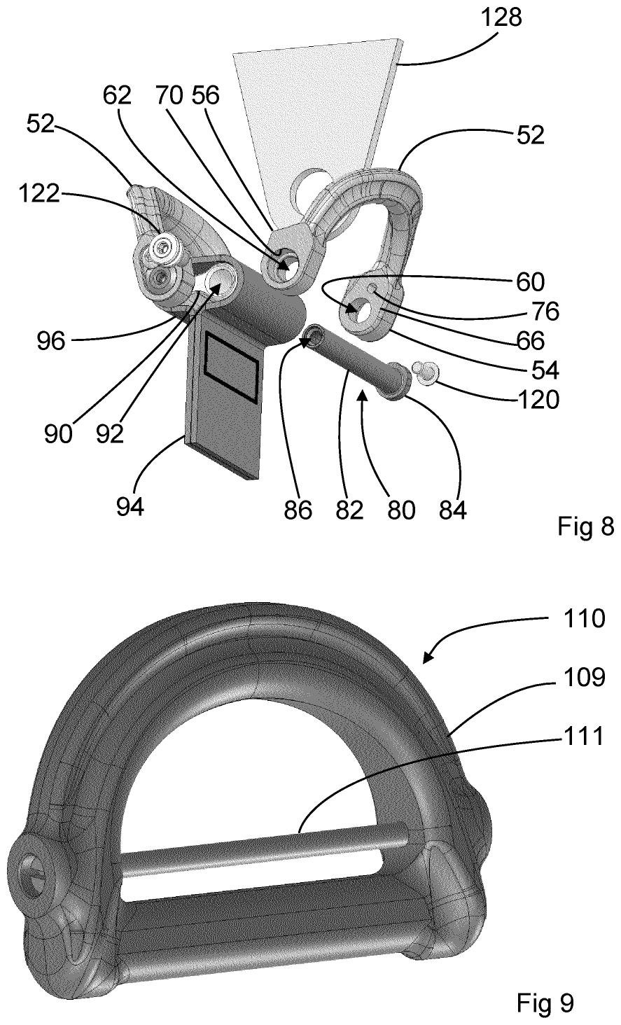

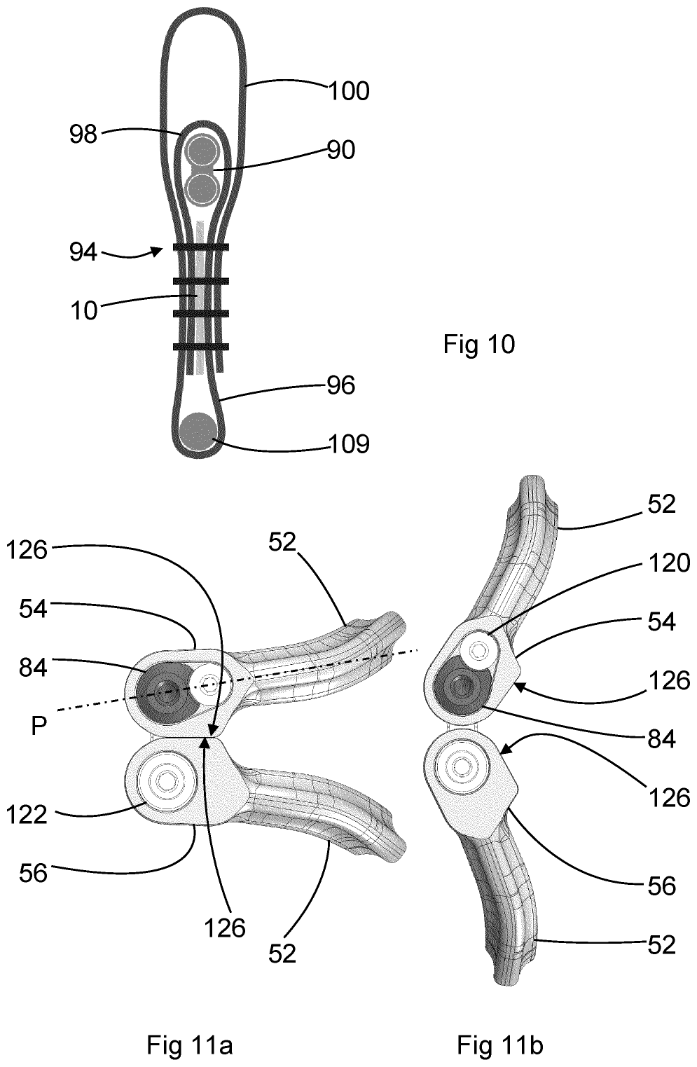

A harness embodying the present invention is shown in FIGS. 1 and 2. The harness comprises two main assemblies. A lower assembly, which can be used as a stand-alone sit harness, and an upper assembly that acts as a supplementary support for a user's upper body. In a preferred mode of operation, the lower assembly serves to support a user's weight while working at height, and the upper assembly acts as a fall-arrest harness and aid the carrying of heavy tools placed upon the lower assembly.

The lower assembly comprises a waist belt that, in use, encircles a user's waist. The waist belt includes a load-bearing waist webbing 10 that has a connector that enables it to be releasably formed into a closed loop and enables its length to be adjusted to fit a user. The waist belt also includes a padded back 12 that transfers load from the waist webbing 10 to a user's body. The waist webbing 10 secures a pair of side connection arrangements 20 to the waist belt, the side connection arrangements 20 being located approximately at a user's hips when the harness is in use. The waist webbing 10 extends between the connection arrangements 20. The waist belt further extends between the connection arrangements 20 around the back of the harness, where it is typically made-up form multiple lengths of webbing extending roughly in parallel.

The lower assembly further includes a pair of leg loops that, in use, encircle a user's thighs. Each leg loop includes a load-bearing webbing leg loop 14 of adjustable length and padding 16 to distribute load on the user's legs. Each leg loop 14 passes through a respective forward connection arrangement 30. A respective riser webbing 18 connects each forward connection arrangement 30 to a corresponding side connection arrangement 20.

A flexible load bearing member (also known as a “bridge”) extends across the front of the harness and is secured to the forward connection arrangements 30. In this example, the rope bridge comprises two lengths of rope 32′, 32″ running in parallel between the forward connection arrangements 30. For use, each rope 32′, 32″ of the bridge carries a sliding attachment device (metal rings 34′, 34″ in this embodiment), which is attached, for use, to an anchoring line 36. Alternative implementations of a bridge can be employed, e.g. using webbing and/or knotted rope.

The upper assembly includes a length of webbing 40 that extends in a loop from attachment hardware 42 connected to a rear part of the waist belt in two lengths 40′, 40″ that, in use, extend over a user's shoulders, to connect with a hardware attachment loop 43, located, in use, approximately centrally in front of a user. The attachment hardware loop is connected to a connecting piece 44 formed from a length of webbing maintained in the required configuration with a length of transverse stitching 45. The connecting piece 44 has a length of webbing (an inner bight) that passes through the hardware attachment loop 43, whereby the hardware attachment loop 43 is permanently secured within the connecting piece 44. A further upwardly-directed upper bight 49 of the connecting piece 44 forms a sternal attachment point that is intended to be loaded in an upward direction. The connecting piece further includes a lower bight 47 below the transverse stitching 45. A fastener, such as a carabiner 46, is passed through the lower bight 47. The carabiner 46 is secured to lower assembly through a ventral attachment assembly 50.

The ventral attachment assembly 50 includes a sewn webbing loop 94, the configuration of which can be seen from FIG. 9. The webbing loop 94 has a single lower bight 96 and an inner upper bight 98 and an outer upper bight 100, the inner upper bight 98 being enclosed within the outer upper bight. End portions of the webbing loop are sewn through one another, through intermediate regions of the webbing loop and through a central front part of the waist webbing 10. When the harness is in use, the lower bight 96 extends generally towards a user's legs, while the upper bights 98, 100 extend from the waist webbing 10 towards a user's upper body. The carabiner 46 passes through the outer upper bight 100 of the webbing loop.

The ventral attachment assembly 50 further includes a lower D-ring sub-assembly 110. Formed from two metal pieces, the lower D-ring sub-assembly 110 has a first D-ring component 109 that has a straight back portion ends of which are interconnected by an arcuate portion. The D-ring sub-assembly 110 further includes a retention bar 111. The retention bar 111 has a head at one end that includes a drive formation (in this case, a slot) that enables it to be rotated by a suitable tool. A portion of the retention bar 111 at the opposite end from the head is externally threaded. The D-ring component 109 has a first through hole close to one end of the straight back portion into which the head is received. A second through hole, aligned with the first through hole, extends through the D-ring component 109 at the opposite end of the straight back portion. The first through hole is tapped to receive the threaded portion of the bar 111 that is adjacent to the. A thread locking compound is used to secure the threaded portion semi-permanently in the second through hole. The straight back portion extends through the lower bight 96 of the webbing loop 94, wherein it is permanently retained (that is to say, it cannot be removed without unsewing the webbing loop). The lower bight 96 passes between the retention bar 111 and the straight back portion to restrict its movement within the lower D-ring sub-assembly 110.

A respective link webbing 112 interconnects the lower D-ring sub-assembly 110 and a respective leg loop 14. Each link webbing 112 is formed from a length of webbing that is folded back upon itself to form two bights and an intermediate region of sewing. One bight of each link webbing 112 surrounds the arcuate portion of the lower D-ring 110 sub-assembly, while the other surrounds one of the leg loops 14.

The D-ring sub-assembly 110 is advantageous because it allows components connected to it to rotate with respect to one another and to the D-ring sub-assembly 110, thereby offering a user maximum freedom of movement. In alternative embodiments, the function of the lower D-ring assembly 110 can be implemented using alternative components such as a suitably constructed assembly of webbing components.

The harness as described above is complete and suitable for use. However, embodiments of this invention allow additional functionality to be added to the harness through the provision of additional ventral attachment hardware. Both the inner and outer upper bights 98, 100 can provide structural, high-strength attachment points to which connections can be made.

In this embodiment, the ventral attachment assembly 50 further includes ventral attachment hardware. The ventral attachment hardware includes two interconnected D-ring assemblies and a connecting piece 90.

Each D-ring assembly includes a metal attachment link 52. The attachment link 52 has first and second bosses 54, 56 between which a length of approximately circular cross-section, extends in an approximately semi-circular arc. The bosses 54, 56, externally, are mirror images of one another about a plane that extends through the centre of the arc. The arc extends from the bosses in a plane P, and, remote from the bosses, curves out of the plane P (see FIG. 11a).

First and second bores 60, 62 respectively extend through each of the bosses 54, 56, the bores being coaxial and centred on the plane P. The bore of each boss opens through a flat bearing surface 66, 68 formed on the boss, the flat surfaces being parallel, mutually facing and spaced apart Each bore 60, 62, at its end opposite the bearing surfaces 66, 68, opens into a counterbored recess. In the second boss 56, the counterbored recess 70 has a simple circular cross-section of diameter greater than the bore. In the first boss 54, the recess 72 additionally includes a radially-extending extension 74. A tapped bore 76 extends into the boss within the extension 74 parallel to the axis of the bore 60.

Each D-ring assembly further includes an axle bolt 80. The axle bolt 80 has a cylindrical shaft 82 at one end of which is a head 84. The head extends radially beyond the shaft and is formed with an arcuate notch 88 into its edge. A coaxial tapped bore 86 extends into the shaft from an end surface remote from the head 84. The shaft 82 is a close sliding fit within the bores 60, 62.

The D-ring assemblies are interconnected by a connecting piece 90. The connecting piece 90 is formed as a one-piece metal component that is symmetrical about a centre plane. The connecting piece 90 has two parallel bores 92 that extend parallel to and on opposite sides of the centre plane. Each bore 92 extends through a flat outer bearing surface of the connecting piece 90, the bearing surfaces being parallel and spaced apart by a distance just less than the spacing between the bearing surfaces 66, 68 of the attachment link 52. The bores 92 have a diameter such that the shafts 82 of the axle bolts 80 are a close sliding fit within the bores 92.

The ventral attachment hardware is retained within the inner upper bight 98 of the webbing loop 94. The dimensions of the webbing that forms the webbing loop 94, the size of the inner upper bight 98 and the connecting piece 90 are selected such that the width of the webbing component 94 is approximately the same as the distance between the bearing surfaces of the connecting piece 90, and such that the inner upper bight 98 is a close fit around the connecting piece 90.

The ventral attachment hardware is assembled by inserting the connecting piece 90 into the inner upper bight 98 until the webbing that forms it is approximately centrally located on the connecting piece 90. One of the attachment links 52 is then mounted on the connecting piece 90 by placing the bearing surfaces 66, 68 of the attachment link 52 adjacent to the bearing surfaces of the connecting piece 90, with the bores 60, 62 in alignment with one of the bores 92 of the connecting piece 90. The axle bolt 80 is then installed by inserting its shaft through the bore 60 in the first boss 54, through the aligned bore 92 in the connecting piece 90, into the bore 62 in the second boss 56. The head 84 of the axle bolt 80 enters into the countersunk recess 72 in the first boss 54 and is rotated such that the notch 88 is adjacent to the tapped bore 76 within the extension 74 of the recess 72.

To secure the axle bolt 80 in the attachment link 52, a main retaining screw 122 that has a head and a threaded shaft is provided. The shaft of the main retaining screw 122 is threaded into the tapped bore 86 in the axle bolt 80, with the head of the main retaining screw 122 being received within the counterbored recess 70 in the second boss 56. The head of the main retaining screw 122 has a circumferential groove within which an O-ring (not shown) is received. The O-ring projects radially from the head to make contact with the material of boss 56 surrounding the counterbored recess 70, thereby creating a frictional resistance to rotation of the main retaining screw 122 to prevent it from loosening unintentionally. The main retaining screw 122 clamps the second boss 56 against the end surface of the axle bolt 80, so resisting any tendency of the attachment link 52 to deflect under load in such a manner that that bosses 54, 56 spread apart.

In order to retain the axle bolt 80 against accidental removal, a secondary retaining screw 120 that has a head and a threaded shaft is provided. The shaft of the secondary retaining screw 120 is threaded into the tapped bore 76 within the extension 74 of the recess 72, with the head of the secondary retaining screw 120 being received within notch 88 in the head 84 of the axle bolt 80. The secondary retaining screw 120 prevents both rotational movement and sliding movement of the axle bolt 80 with respect to the attachment link 52, even if the main retaining screw 122 is absent.

The second D-ring assembly can be constructed by installing its attachment link 52 on the connecting piece 90 in the same manner.

Once assembled in this way, each attachment link 52 provides a location for the attachment of external hardware to the ventral attachment assembly 50. Each attachment link 52 can pivot with respect to the connecting piece 90, such pivoting movement being accommodated by the axle bolt 80 pivoting within the bore 92 of the connecting piece 90. In addition, the connecting piece 90 can pivot within inner upper bight 98 of the webbing loop 94. This reduces the likelihood that the connecting piece will apply a twisting load to the webbing loop 94 in the event that the attachment links 52 are loaded asymmetrically.

As shown in FIGS. 11a and 11b, the first and second bosses 54, 56 are shaped to limit the extent to which the attachment links 52 can pivot on the connecting piece 90, particularly, how closely they can approach one another. Each boss 54, 56 includes a flat abutment surface 126 that extends in a plane that extends at an angle of approximately 100 from the plane P and is radially offset from the axes of the bores 60, 62 in the bosses 54, 56. Pivoting the attachment links 52 towards one another about the axle bolts 80 eventually brings the abutment surfaces 126 into contact with one another, whereupon further pivotal movement is prevented. In this position, the arcuate lengths of the attachment links 52 are spaced apart, to ensure that nothing (for example, an ascender, a rope, a carabiner or a webbing) can become trapped between them.

It is clearly possible to attach and remove a carabiner or similar device from the attachment links 52 while they are installed upon the connecting piece 90 by clipping them onto the arcuate length of an attachment link 52. It is also possible to connect or disconnect a component with a captive hole, such as an ascender 128 travelling on a climbing line 130 or a sewn eye 132 at the end of a rope 134. This is achieved by passing a boss 54, 56 of the attachment link 52 through the captive hole before installing the attachment link 52 on the connecting piece 90. The component is removed after removal of the attachment link 52 from the connecting piece 90.

The harness of this embodiment additionally provides a seat assembly that comprises a seat board 180 of rigid material covered with foam and fabric to act as a supporting platform upon which a person can sit. The seat board 180 is approximately rectangular with upturned, curved end portions. A length of webbing 182 passes beneath the seat board and is sewn to the fabric covering, the webbing 182 and terminating at each end in a sewn loop 184. The webbing 182 has a buckle to enable its length to be adjusted. In WO-A-2020/065279, the webbing is connected to the forward connection arrangements of the harness (which is also possible in the present embodiment).

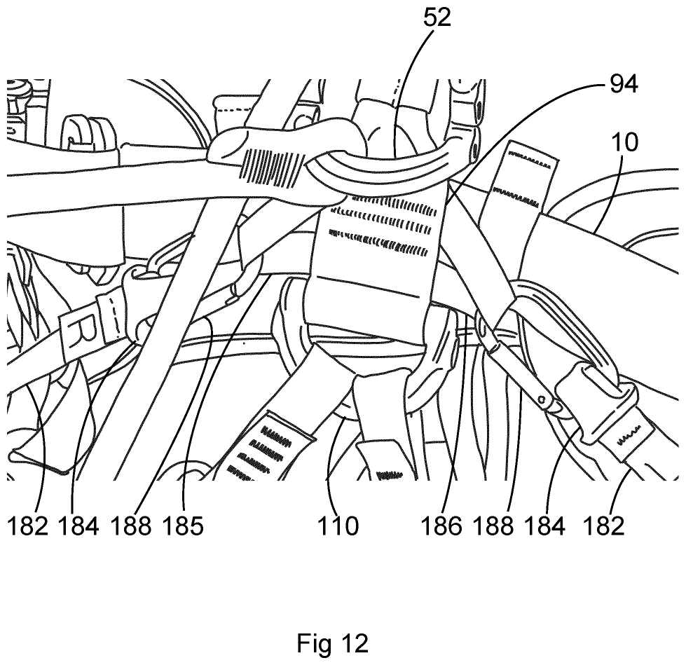

The present embodiment provides an alternative connection point for the seat assembly. As shown most clearly in FIG. 12, the webbing loop 94 further includes a sewn-in supplementary webbing that forms a pair of supplementary connection bights 186 that project to opposite sides of the webbing loop 94 and are folded into a triangular shape to cause them to lie generally flat in a plane. The sewn loops 184 of the seat webbing 182 can be releasably connected to the supplementary connection bights 186 by way of a carabiner 188 or other suitable connector.

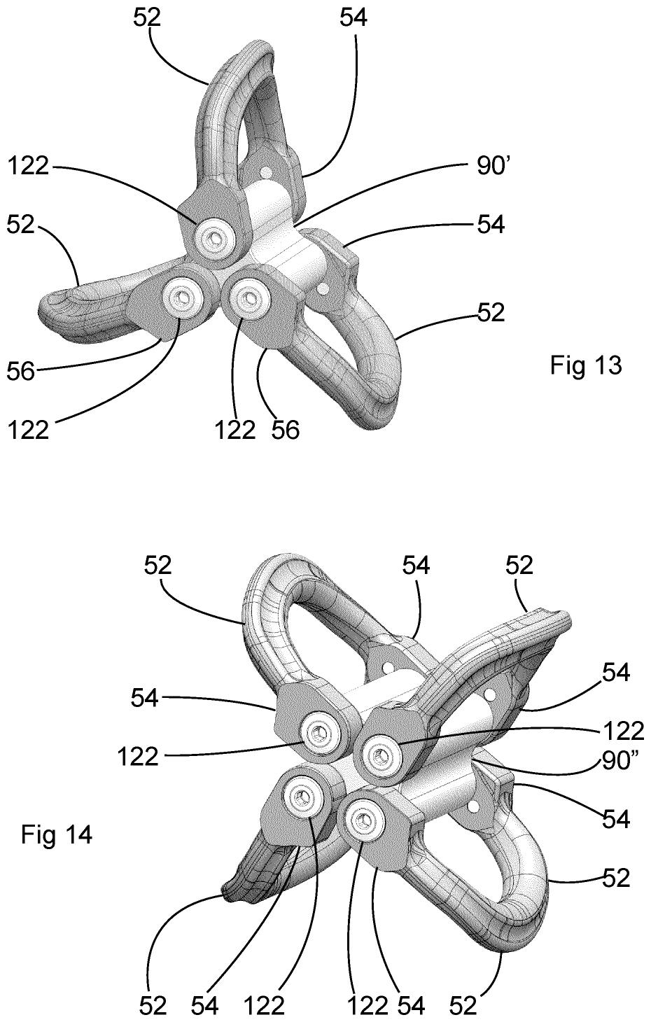

Alternative embodiments of front harness hardware are shown in FIGS. 13 and 14. These embodiments use D-ring assemblies identical to those described above; the embodiment of FIG. 12 includes three D-ring assemblies and the embodiment of FIG. 14 includes four. This is achieved by replacing the connecting piece 90 of the first embodiment with a connecting piece 90′ that has three bores or a connecting piece 90″ that has four bores, a D-ring assembly being carried on each of the bores.

Furthermore, it will be understood that components or assemblies other than the D-ring assemblies described above can be connected to the various connecting pieces (90, 90′, 90″). A range of components (typically, metal hardware components) can be provided that include formations that correspond to the bosses 54, 56, which formations enable connection to the connecting pieces (90, 90′, 90″).

1. A harness for supporting a person working at height comprising:
a. a waist belt;
b. a pair of leg loops;
c. a ventral attachment assembly, wherein the ventral attachment assembly comprises a flexible structural component that is secured to the waist belt, and that is arranged to form a lower bight within which a connecting piece is retained, and at least one upper bight that provides a connection point through which loads can be transferred into the waist band; and
d. one or a pair of link components, each being connected to the connecting piece and to at least one of the leg loops, the link components being capable of acting in tension to transfer load from the waist and/or leg loops to the ventral attachment assembly.

2. The harness according to claim 1, in which one or more of the waist belt, the leg loops and the link component are formed from lengths of webbing.

3. The harness according to claim 1, in which the flexible structural component is formed from a length of webbing that is secured to the waist belt and that is permanently configured to provide the lower bight and the at least one upper bight by stitching through the webbing into the waist belt.

4. The harness according to claim 1, in which the at least one upper bight of the flexible structural component includes inner and outer upper bights, the inner upper bight being enclosed within the outer upper bight.

5. The harness according to claim 1, in which the ventral attachment assembly further includes ventral attachment hardware that is retained by the flexible structural component and which provides one or more link components to which a connector can be attached to transfer load between the harness and an external component.

6. The harness according to claim 5, in which the ventral attachment hardware includes a plurality of link assemblies interconnected by a connecting piece.

7. The harness according to claim 6, in which each link assembly pivotally connected to the connecting piece.

8. The harness according to claim 7, in which each link assembly can pivot upon the connecting piece about axes that are parallel to one another.

9. The harness according to claim 7, in which at least one link assembly includes an abutment that is disposed to make contact with part of another link assembly to limit the extent to which the link assemblies can pivot towards one another.

10. The harness according to claim 6, in which the link assemblies are identical.

11. The harness according to claim 6, in which the connecting piece is retained within one of the upper bights of the flexible structural component.

12. The harness according to claim 11 in which the connecting piece can pivot within the upper bight of the flexible structural component.

13. The harness according to claim 6, in which each link assembly includes an attachment link and a removable axle bolt which together form a closed loop, the loop being openable by removal of the axle bolt.

14. The harness according to claim 13 in which each axle bolt is pivotably retained within a bore of the connecting piece.

15. The harness according to claim 6, in which each link assembly is generally D-shaped.

16. The harness according to claim 1, in which the ventral attachment assembly includes a pair of supplementary connection points to which additional accessory component of the harness can be connected.

17. The harness according to claim 16 which further includes a seat assembly, in which the seat assembly includes a seat board and a connection component, which connection component is connected to the supplementary points.

18. The harness according to claim 17 in which the connection component is connected to each supplementary connection point by a releasable connector.
